(19) United States
(12) Patent Application Publication
(10) Pub. No.: US 2003/0100443 A1
(43) Pub. Date: May 29, 2003

(54) Oxidation-insensitive polymer-stabilized noble metal colloids

(75) Inventors: Michael Bender, Ludwigshafen (DE); Helge Wessel, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/303,830

(22) Filed: Nov. 26, 2002

(30) Foreign Application Priority Data
Nov. 26, 2001 (DE) 10157916.0

(51) Int. Cl. B01J 23/00; B01J 21/18; B01J 31/00

(52) U.S. Cl. 502/159; 502/180; 502/182

(57) ABSTRACT

In an oxidation-insensitive polymer-stabilized noble metal colloid comprising noble metal particles which have one or more oxidation-insensitive polymers containing sulfonic acid groups or phosphonic acid groups coordinated to their surface, the polymers are selected from the group consisting of sulfonated, partially fluorinated or fluorinated polystyrene, sulfonated, partially sulfonated or fluorinated alkylene-styrene copolymers, sulfonated, perfluorinated alkylene-alkylene oxide copolymers, sulfonated polystyrene, sulfonated polyarylene oxides, sulfonated polyarylene ether sulfones, sulfonated polyarylene ether ketones, sulfonated polyphenylene, sulfonated polyphenylene sulfide and phosponated arylene oxides and phosphonated polybenzimidazoles, with the polymers mentioned being able to bear further substituents.

The present invention relates to oxidation-insensitive polymer-stabilized noble metal colloids.

Metal colloids are systems in which metal particles having a diameter in the approximate size range from about 1 nm to 1 μm are present. The extremely finely divided metal itself is referred to as colloidal metal. It can be present as such, be dispersed in a continuous phase or be adsorbed at a phase boundary. Its dispersion in a solvent is referred to as metal colloid solution.

The preparation of metal colloids has been known for a long time. It is usual to reduce metal salts to the metal in solution in the presence of stabilizers. These stabilizers are substances which are able to form coordinate bonds to the metal and thereby protect the metal particles formed from agglomeration. Properties such as the size and size distribution of the colloid particles formed can be influenced by choice of the reducing agent, of the protective ligand and its amount, of the solvent and of the anion present in the metal salt.

DE-A 44 12 463 discloses the preparation of palladium colloid solutions by reduction of palladium salts by means of a series of reducing agents such as phosphites, hypophosphites, boranes, ascorbic acid, hydrazine and formaldehyde in the presence of polymeric stabilizers such as polyvinylpyrrolidone, polyvinylpyridine, polyvinyl methyl ketone, polyvinyl alcohol, polyvinyl acetate, polyacrylate, alkylcellulose and hydroxyalkylcellulose.

H. Bönnemann et al., Angewandte Chemie 103 (1991), pages 1344 to 1346, describe the preparation of metal colloids of elements of groups 6 to 11 in an organic phase. The metal salts are suspended in THF and reduced by means of tetralkylammonium hydrotriorganoborates. The ammonium salt formed in this way acts as protective colloid for the metal particles formed, so that the addition of external stabilizers is not necessary.

DE-A 196 30 581 discloses a process for preparing solvent-stabilized transition metal colloids having a particle size of from 1 to 15 nm, in which a transition metal salt such as PdCl₂, Pd(OAc)₂, Pd(acac)₂, Ni(OAc)₂, Fe(acac)₂, Fe(OAc)₃, PtCl₂, Pt(OAc)₂, RhCl₃, Rh(OAc)₃, Co(OAc)₂, Cu(OAc)₂, AgOAc or Ag₂CO₃ in polar solvents such as organic carbonates, carboxamides, sulfonamides or urea derivatives, preferably in propylene carbonate, is reduced by means of an alcohol such as isopropanol or methanol.

Metal colloids of noble metals such as palladium are widely used as catalysts. Particularly small particle sizes of the metal colloid particles are desirable here, since the available surface area of the catalyst increases in inverse proportion to the particle diameter. The activity of the catalyst is therefore usually directly related to the size of the catalytically active metal particles. The metal colloid can be used in free, unsupported form. The metal colloid is then separated from the product solution by, for example, membrane filtration. However, the metal colloid can also be immobilized on a catalyst support for use as a catalyst.

H. Bönnemann et al., Angewandte Chemie 103 (1991), pages 1344 to 1346, mention the use of supported metal colloids as catalysts for the hydrogenation of unsaturated compounds such as carbon monoxide, C—C—, C—O—, C—N multiple bond systems and for the hydrogenation of aromatic compounds and mention the use of free Pd and Ni colloids as catalysts for the selective hydrogenation of natural products such as soybean oil.

To be able to be used as a catalyst, the metal colloid has to be stable in the reaction environment. This is not a problem in hydrogenations of organic compounds in the liquid phase. However, if oxygen or other oxidizing reagents are present in the reaction environment, as in the case of partial oxidations of organic or inorganic compounds using oxygen or hydrogen peroxide, decomposition of the polymer which stabilizes the colloid can occur. Oxidative degradation of the stabilizer leads to decomposition of the colloid with the colloid sedimenting in the reaction space and becoming catalytically inactive as a result.

DE-A 44 12 463 discloses a process for coating electrically nonconductive substrate surfaces with metal coatings, in which the substrate surfaces are treated with a palladium colloid solution. The palladium colloid is stabilized by protective colloids such as polyvinylpyrrolidone, polyvinylpyridine, polyvinyl methyl ketone, polyvinyl alcohol, polyvinyl acetate, polyacrylic acid, polyethylene glycol, polyimine or alkylcellulose and hydroxyalkylcellulose. The palladium colloid solution is brought into intimate contact with oxygen in the coating process. To reduce the oxidation sensitivity of the colloids, this document teaches the addition of reducing agents such as metal hypophosphites and phosphites, alkali metal borohydrides, monoalkylaminoboranes, dialkylaminoboranes, trialkylaminoboranes, ascorbic acid, hydrazine, hydroxylamine or formaldehyde to the palladium colloid solution. The oxygen oxidizes these instead of the stabilizing polymer. In the case of the electrochemical process described there, this may well be a suitable solution to the problem of oxidation-sensitivity of the metal colloids used. However, if catalytic oxidation reactions are to be carried out in the presence of the colloid, the presence of a reducing agent causes considerable interference to the course of the reaction.

Particularly aggressive oxidizing conditions are encountered in the direct synthesis of hydrogen peroxide from the elements. Here, the oxygen dissolved in the reaction medium and the hydrogen peroxide formed have an oxidizing action. These oxidants have a particularly aggressive action in the presence of the halide ions usually used for stabilizing the hydrogen peroxide.

It is an object of the present invention to provide an oxidation-insensitive noble metal colloid which can be used as catalyst for oxidation reactions.

We have found that this object is achieved by an oxidation-insensitive polymer-stabilized noble metal colloid comprising noble metal particles which have one or more oxidation-insensitive polymers containing sulfonic acid groups or phosphonic acid groups coordinated to their surface, where the polymers are selected from the group consisting of sulfonated, partially fluorinated or fluorinated polystyrene, sulfonated, partially sulfonated or fluorinated alkylene-styrene copolymers, sulfonated, perfluorinated alkylene-alkylene oxide copolymers, sulfonated polystyrene, sulfonated polyarylene oxides, sulfonated polyarylene ether sulfones, sulfonated polyarylene ether ketones, sulfonated polyphenylene, sulfonated polyphenylene sulfide and phosponated arylene oxides and phosphonated polybenzimidazoles, with the polymers mentioned being able to bear further substituents.

Suitable sulfonated partially fluorinated alkylene-styrene copolymers comprise, for example, the structural units (I) or (II):

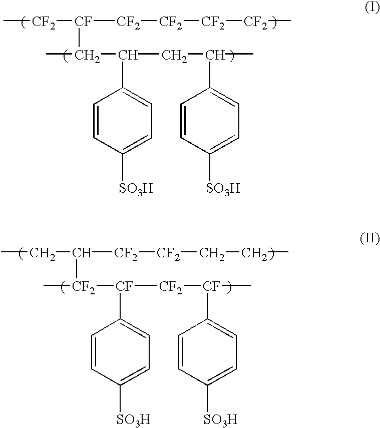

Polymers of this type are obtainable, for example, under the names Raipore® R-1010 from Pall Rai Manufacturing Corporation, USA, and Raymion® from Chlorine Engineering Corporation, Japan.

A suitable sulfonated fluorinated polystyrene is, for example, sulfonated polytetrafluorostyrene comprising the structural unit (III):

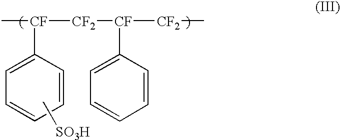

Suitable sulfonated, fluorinated polystyrene can also be crosslinked by means of structural units (IIIa):

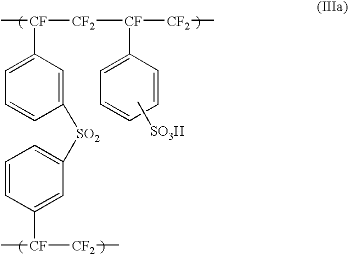

Suitable perfluorinated alkylene-alkylene oxide copolymers comprise, for example, the structural units (IV) and (V):

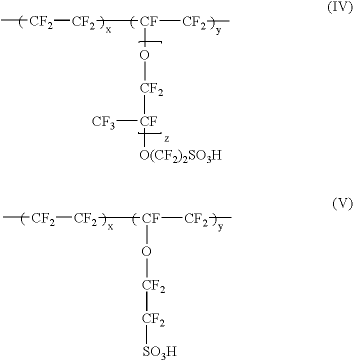

Such polymers are obtainable, for example, under the names Nafion® from Dupont, USA and Aciplex-S® from Asahi Chemicals, Japan.

Suitable sulfonated polyarylene oxides comprise, for example, repeating units of the formula (VI):

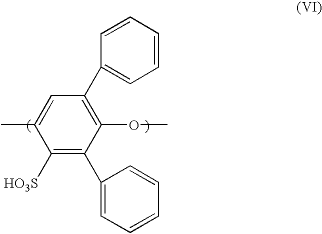

Suitable polyaryl ether sulfones comprise, for example, repeating units of the formulae (VII) and (VIII):

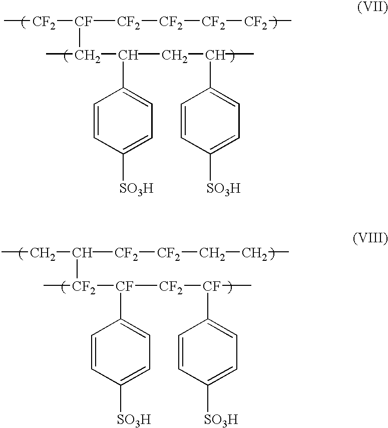

Suitable sulfonated polyarylene ether ketones comprise, for example, repeating units of the formula (IX):

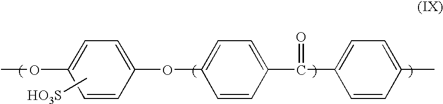

Suitable phosphonated arylene oxides comprise, for example, repeating units of the formulae (Xa)-(Xc):

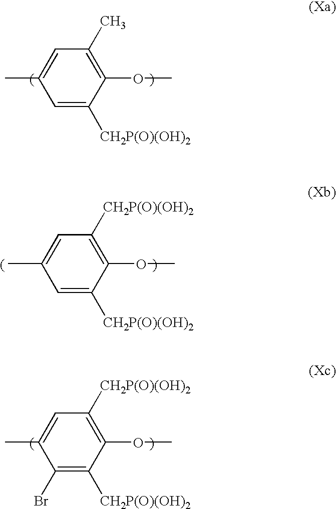

Further suitable oxidation-insensitive stabilizing polymers are polyphenylene, polyphenylene sulfide, sulfonated polystyrene which may be crosslinked by means of divinylbenzene and also sulfonated linear or crosslinked phenol-formaldehyde resins.

The term “structural unit” employed above refers to illustrative, representative sections of the overall structure of the polymers used according to the present invention.

Preferred oxidation-insensitive, stabilizing polymers are the abovementioned sulfonated partially fluorinated, fluorinated and perfluorinated polymers and the polymers containing phosphonic acid groups. Particular preference is given to perfluorinated alkylene-alkylene oxide copolymers, for example the polymers obtainable under the name Nafion®.

The noble metal colloid is prepared by reacting a solution of the noble metal salts with one or more reducing agents in the presence of the oxidation-insensitive stabilizing polymer or polymers. For this purpose, for example, a solution of the reducing agent is mixed with a solution of the noble metal salt, with the latter additionally containing the stabilizing polymer. As noble metal salts, it is possible to use all soluble salts which can be reduced to the metallic noble metal colloids by means of reducing agents. Examples are the chlorides, sulfates, nitrates, phosphates, pyrophosphates, cyanides and fluoroborates of the noble metal, also its organic salts, e.g. the salts of formic, acetic, succinic, malic, lactic, citric, ascorbic, oxalic, benzoic and vanillic acids, and also complexes such as amine and halide complexes of the noble metal and complexes of the noble metal with organic complexing agents.

Preferred noble metals are palladium, platinum, rhodium, ruthenium and iridium.

Particularly preferred noble metals are palladium and platinum, which are generally used as palladium(II) and platinum(II) salts. Preference is given to the nitrates and carboxylic acid salts, e.g. acetates, of palladium(II) and platinum(II).

Solutions of a plurality of different noble metal salts can also be reacted.

To obtain noble metal colloids which further comprise additional metallic components, it is possible to make concomitant use of appropriate metal salts of one or more further metals of main groups III and IV, e.g. gallium, germanium, tin and lead, and of transition metals, e.g. rhenium, copper, nickel, cobalt, manganese, chromium and molybdenum.

Suitable reducing agents are alcohols such as ethanol and aldehydes such as formaldehyde.

The preparation of the noble metal colloids can be carried out in polar or nonpolar solvents. The preparation can, for example, be carried out in an aqueous solvent in which the reducing agent is present in dissolved form. However, it is also possible to employ nonaqueous solvents in which the reducing agent is present. Examples are alcohols, acetic acid, THF, ethers and formaldehyde. In a preferred embodiment of the invention, the preparation is carried out in the reducing agent as solvent. Preferred reducing agents which can simultaneously be solvents are ethanol and formaldehyde.

The reduction of the noble metal salt is generally carried out by stirring the solution comprising the noble metal salt, if desired the further metal salt, the stabilizing polymer and the reducing agent at from 0 to 95° C., preferably from 30 to 90° C., for a period of from 10 to 200 minutes, preferably from 30 to 150 minutes.

The colloidal noble metal can be precipitated from the noble metal colloid solution prepared in this way by addition of a very nonpolar solvent and subsequently be isolated. Suitable very nonpolar solvents are, for example, aliphatic, aromatic or cycloaliphatic hydrocarbons having from 5 to 10 carbon atoms. In particular, the addition of petroleum ether as precipitant has been found to be useful. The precipitated noble metal colloid can be isolated by customary mechanical separation methods, for example by filtration or centrifugation. The polymer-stabilized noble metal colloids of the present invention are stable to air even in solid form, so that they can be dried in air after they have been isolated.

The polymer-stabilized noble metal colloid of the present invention can be used as catalyst. For this purpose, the noble metal colloid solution obtained in the reduction of the noble metal salt can be used directly. The isolated noble metal colloid can also be redispersed in a liquid medium to form a noble metal colloid solution. The noble metal colloid of the present invention can also be applied to a support.

The noble metal particles formed typically have particle diameters in the range from 1 to 10 nm, preferably from 1 to 5 nm.

The polymer-stabilized noble metal colloid of the present invention can be further processed to produce a heterogeneous catalyst by applying it to a support. Possible supports are all customary supports such as ceramic oxides, preferably Al₂O₃, SiO₂, ZrO₂, TiO₂ and mixed oxides thereof, carbon, zeolites and silicalites. The supports may comprise promoters for increasing the catalytic activity and the sintering stability.

The noble metal colloid can be applied to the support from solution. For this purpose, the support is impregnated with the noble metal colloid solution, for example by spraying the support with the solution or by steeping the support in the solution. Impregnation can be followed by a drying step. However, the noble metal colloid can also be applied to the support by dry mixing the isolated noble metal colloid with the support.

The weight ratio of noble metal to stabilizing polymer during the preparation of the noble metal colloids is generally from 60:1 to 1:60, preferably from 30:1 to 1:30.

The noble metal oxide of the present invention can be used as catalyst for oxidation reactions. Here, the noble metal colloid can be used as a solution or as a heterogeneous catalyst on a support. A preferred oxidation reaction is the synthesis of hydrogen peroxide from the elements, both by the anthraquinone process or an analogous process and by means of direct synthesis, i.e. by direct reaction of oxygen and hydrogen over the noble metal colloid in a liquid or gaseous medium.

The noble metal colloid of the present invention can also be used as electrocatalyst in fuel cells, in particular in PEM fuel cells or in DMFC fuel cells. For this purpose, the noble metal colloid, preferably a platinum colloid according to the present invention, is combined with carbon black (e.g. Vulcan X C 72 from Cabat, Inc.) and used as electrocatalyst.

The invention is illustrated by the following examples:

### EXAMPLES

### Example 1

750 mg of Nafion® as a 5% strength by weight ethanolic solution and 75 ml of ethanol are placed in a 500 ml four-neck flask and 75 mg of palladium as Pd(MO₃)₂ dissolved in 25 ml of ethanol are added. The resulting solution is initially clear and light brown in color. It is stirred at room temperature for 4 hours. After this time has elapsed, the solution is black and turbid due to the palladium colloid formed.

The solution is made up to 125 ml with ethanol. It contains 0.6 g of Pd/1. To stabilize the colloidal solution, the volume is doubled by addition of distilled water and ethanol is slowly distilled off on a water bath. This converts the palladium colloid into an aqueous, stable solution.

### Comparative Example 1

For comparison with the Nafion®-stabilized palladium colloid, a PVP-stabilized palladium colloid as is frequently described in the literature is prepared. For this purpose, 50 ml of an aqueous Pd(NO₃)₂ solution having a palladium content of 3 g and 400 ml of water are placed in a 2 l flask. 50 ml of an aqueous solution of 3 g of polyvinylpyrrolidone are added to this solution. 500 ml of ethanol are subsequently added and the still clear solution is heated to boiling. It is subsequently stirred for 3 hours under reflux. The solution is allowed to cool, the resulting sol is made up to 1 l with water and ethanol is slowly distilled off on a water bath. The resulting solution is made up to 1 l with water.

### Example 2

To demonstrate the oxidation stability, 1 ml of the Nafion®-stabilized palladium colloid solution prepared as described in Example 1 is admixed with about 2 ml of 30% strength by weight H₂O₂ solution. Immediately after addition of H₂O₂, vigorous gas evolution commences as a result of the decomposition of hydrogen peroxide into water and oxygen. After the decomposition reaction is complete, the Nafion®-stabilized palladium colloid is present in unchanged colloidally dispersed form in the solution.

### Comparative Example 2

For comparison, 1 ml of the PVP-stabilized palladium colloid solution prepared as described in Comparative Example 1 is admixed with about 2 ml of 30% strength by weight H₂O₂ solution. After gas evolution has abated, the palladium colloid is present in aggregated form at the bottom of the test vessel.

We claim:

1. An oxidation-insensitive polymer-stabilized noble metal colloid comprising noble metal particles which have one or more oxidation-insensitive polymers containing sulfonic acid groups or phosphonic acid groups coordinated to their surface, where the polymers are selected from the group consisting of sulfonated, partially fluorinated or fluorinated polystyrene, sulfonated, partially sulfonated or fluorinated alkylene-styrene copolymers, sulfonated, perfluorinated alkylene-alkylene oxide copolymers, sulfonated polystyrene, sulfonated polyarylene oxides, sulfonated polyarylene ether sulfones, sulfonated polyarylene ether ketones, sulfonated polyphenylene, sulfonated polyphenylene sulfide and phosponated arylene oxides and phosphonated polybenzimidazoles, with the polymers mentioned being able to bear further substituents.

2. A noble metal colloid as claimed in claim 1, wherein the noble metal is palladium or platinum.

3. A noble metal colloid solution comprising a noble metal colloid as claimed in claim 1.

4. A heterogeneous noble metal catalyst comprising a noble metal colloid as claimed in claim 1 on a support.

5. A heterogeneous noble metal catalyst as claimed in claim 4, wherein the support is selected from the group consisting of Al₂O₃, SiO₂, ZrO₂, TiO₂ and mixed oxides thereof, carbon, zeolites and silicalites.

6. A process for preparing a noble metal colloid solution, which comprises reacting a solution of one or more noble metal salts with one or more reducing agents in the presence of one or more oxidation-insensitive stabilizing polymers selected from the group consisting of sulfonated, partially fluorinated or fluorinated polystyrene, sulfonated, partially sulfonated or fluorinated alkylene-styrene copolymers, sulfonated, perfluorinated alkylene-alkylene oxide copolymers, sulfonated polystyrene, sulfonated polyarylene oxides, sulfonated polyarylene ether sulfones, sulfonated polyarylene ether ketones, sulfonated polyphenylene, sulfonated polyphenylene sulfide and phosponated arylene oxides and phosphonated polybenzimidazoles, with the polymers mentioned being able to bear further substituents.
